(19) United States
(12) Patent Application Publication
(10) Pub. No.: US 2007/0268527 A1
(43) Pub. Date: Nov. 22, 2007

(54) Image forming device

(75) Inventor: Tomonori Naota, Osaka (JP)

Correspondence Address: Kyocera Technology Development;Intellectual Property Administration, Suite 400, 1855 Gateway Blvd., Concord, CA, 94520, US

(73) Assignee: Kyocera Mita Corporation, Osaka-shi (JP)

(21) Appl. No.: 11/807,893

(22) Filed: May 30, 2007

(30) Foreign Application Priority Data
Oct. 24, 2005 (JP) JP 2005-309121

(51) Int. Cl. G06F 3/12

(52) U.S. Cl. 358/462; 358/1.15

(57) ABSTRACT

A method, program product, and system that enables to control a restriction the user may face in using an image forming device when a printer driver or utility software is not installed on a data input device and that successfully allows outputting an image. A printer that acquires print document data from the client PC and outputs a print document includes a filter function unit. The printer function unit consists of a filter configuration management unit that enables management of a filter selectively configured on each of multiple types of interface connected to the client PC, a filter implementation unit implemented with multiple types of filters, and a filter control unit that selectively activates a filter implemented on the filter implementation unit based on management by the filter configuration management unit. The printer function unit also includes a Web function unit that enables filter configuration on a Web page.

### FIELD OF THE INVENTION

The present invention relates to an image forming device provided for a Multifunction Peripherals or Multi-Functional Peripheral (hereinafter “MFP(s)”), a printer, and the like.

### BACKGROUND OF THE INVENTION

Conventionally, for outputting data to an image forming device such as a MFP and a printer, for example, a printer driver installed on a client Personal Computer (hereinafter “PC”) is used for outputting print data created on a client PC to a printer.

In this case, a printer cannot identify some character code documents, requiring converting them into identifiable character code documents for transmission. Such conversion is mainly executed in advance by filter function of client PC's utility software, which performs filter processing of print data transmitted from a client PC to convert into character code documents a printer can identify and transmit the converted data to a printer.

However, as described in Japanese Patent Application Laid-Open No. 2001-154821, when the printer driver or the utility software is not installed on a PC, printer use becomes restricted.

A problem the present invention attempts to address is that printer use by the user becomes restricted in an environment where a PC is not installed with a printer driver or utility software.

### SUMMARY OF THE INVENTION

The present invention addresses the abovementioned issues by providing a filter function unit on an image forming device.

An image forming device of the present invention that acquires data from a data input device and outputs an image, in order to control restrictions on printer use by the user in an environment that a data input device is not installed with a printer driver or utility software, comprises a filter function unit processing the acquired data through a configured filter to enable output of the image.

An image forming device of the present invention is an image forming device that acquires data from a data input device and outputting an image, and comprises a filter function unit that processes the acquired data through a configured filter and enables output of the image, so that even when a printer driver or utility software is not installed on a data input device, data acquired from a data input device can be converted, modified, and so forth into an identifiable data through a configured filter in a filter function unit, to output an image.

These and other objects, features and advantages of the present invention are specifically set forth in or with become apparent from the following detailed descriptions of the invention when read in conjunction with the accompanying drawings.

### DESCRIPTION OF THE DRAWINGS

FIG. 1 is a system configuration diagram.

FIG. 2 is a block diagram illustrating a function unit to be added to a printer

FIG. 3 is a schematic diagram indicating a Web page for filter configuration.

FIG. 4 is a flowchart illustrating application of filter function.

### DETAILED DESCRIPTION OF THE INVENTION

Exemplary embodiments of the present invention are explained below with reference to the accompanying drawings though these embodiments are not intended to limit the invention. Additionally, in some instances, well-known structures, interfaces, and processes have not been shown in detail in order not to unnecessarily obscure the present invention.

An object of controlling restrictions on use of image forming device for the user is accomplished by providing a filter function unit on an image forming device.

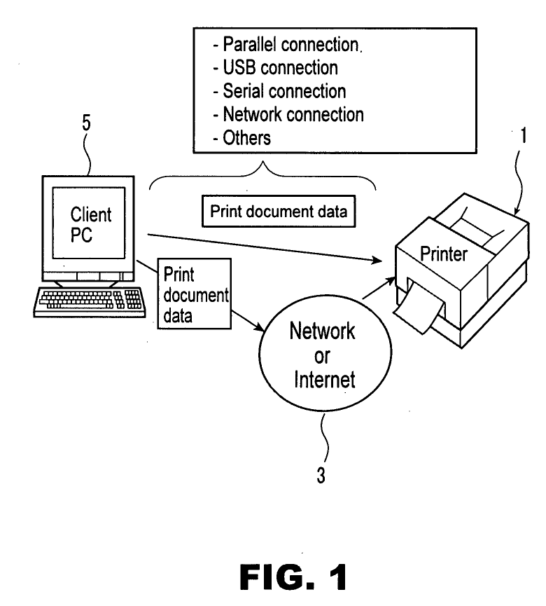

FIG. 1 is a system configuration diagram applying a preferred embodiment of the present invention.

As illustrated in FIG. 1, the printer 1 as an embodiment of an image forming device of the present system comprises various connection interfaces to the client PC 5 on the network or Internet 3, such as a local port for a serial port, a parallel port, a USB port, and the like, and a network port for network or Internet.

An image forming device is functionally sufficient to transmit data and output an image, such as by printing, and therefore, the preferred embodiments of the present invention can be applied, not limited to the printer 1, but to other MFPs.

The client PC 5 (a data input device) creates print document data and transmits the data to the printer 1. The installed OS on the client PC 5 is commonly used Windows® and Unix®, and browser software is also installed.

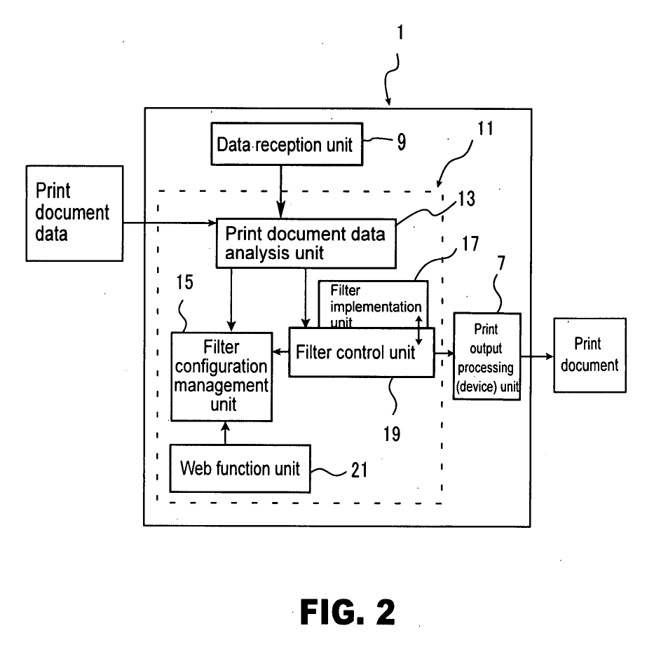

In addition to configurations and functions of a conventional printer, the printer 1 comprises a function unit shown in FIG. 2. FIG. 2 is a block diagram illustrating a function unit added to a printer.

The printer 1 embodies filter function as an internal program. In other words, as shown in FIG. 2, the printer 1 has filter function as an internal program in addition to the print output processing unit 7 and data reception unit 9, and comprises the filter function unit 11. Multiple filters are installed on the printer 1, and the user can select a filter to use among them.

The filter function unit 11 enables print output of acquired print document data as identifiable data by processing through a configured filter, and comprises the print document data analysis unit 13 as a data analysis unit, the filter configuration management unit 15, the filter implementation unit 17, the filter control unit 19, and the Web function unit 21.

The print document data analysis unit 13 has a function of determination, based on configured trigger information and trigger information included in the print document data, whether or not to use a filter.

The trigger information in the preferred embodiments of the present invention is a filter start character string, for example, “START FILTER,” to signal a start of filter use. Furthermore, the trigger information can be configured to comprise another character string and a symbol code, unlimited to a character string.

The trigger information can be a filter start character string signaling a start of filter use and a filter end character string signaling an end of filter use. A filter end character string can be set as “END FILTER,” or composed of another character string and a symbol code, not limited to a character string.

The filter configuration management unit 15 comprises a function to enable the user to manage configuration data of the filter selectively configured on each of multiple types of interfaces connected to the client PC 5.

The filter implementation unit 17 is implemented with multiple types of filters which can include any filter. Users can selectively configure an implemented filter among them on each connection interface.

The filter control unit 19 includes a function of selectively activating a filter corresponding to the filter implementation unit 17 when using a filter based on management of filter configuration data by the filter configuration management unit 15 and a determination by the print document data analysis unit 13.

The Web function unit 21 executes each configuration on the printer 1, and includes a function to enable configuration of the filter on a Web page. Accordingly, users can set up a filter on a connection interface used in printing out a print document by accessing a Web page.

The Web function unit 21 further includes a function to allow choosing a filter selectively configured on each logical port on a network interface.

The user accesses the Web function unit 21 from the client PC 5 to configure and select a filter and transmit print document data to the printer 1. The transmitted print document data is received at the data reception unit 9 on the printer 1. Based on a determination by the print document data analysis unit 13 and management of filter configuration data by the filter configuration management unit 15, the filter control unit 19 activates a filter corresponding to the filter implementation unit 17, and the print output processing unit 7 outputs print document.

For configuring a filter, the user accesses a Web page for the printer 1 through the client PC 5, and selectively configures on the Web page a filter on a connection interface.

Upon filter configuration, the user can encrypt print document data by setting up a parameter to unable for an unauthorized user to read and thereby improve security function.

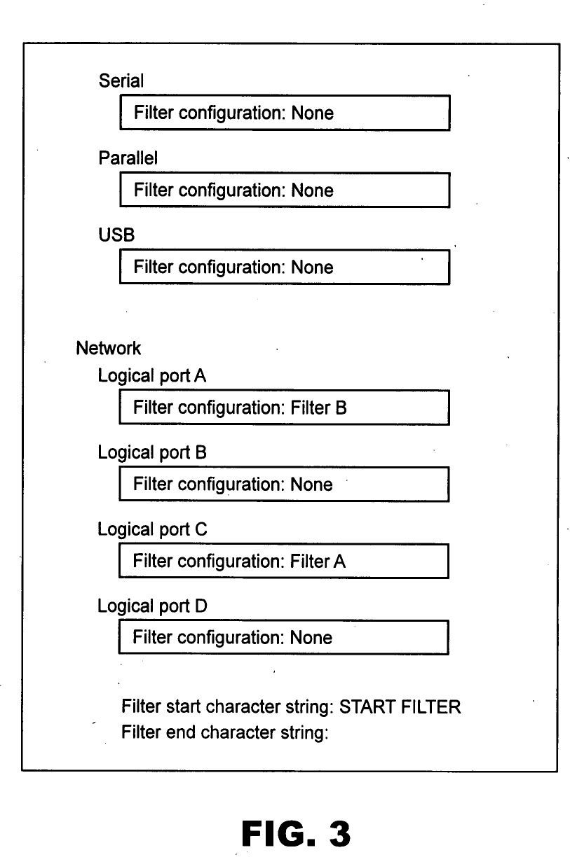

FIG. 3 is a diagram describing a Web page for configuring a filter. FIG. 3 shows a serial port, a parallel port, and a USB port as local interfaces, and the logical port A, B, C, and D as network interfaces, on all of which a filter can be configured.

In FIG. 3, a filter is not configured either on a serial port, a parallel port, or a USB port. The filter B is configured on the logical port A, the filter A is configured on the logical port C, and no filter is configured either on the logical port B or D.

When configuration of items is completed, clicking the “confirm” button on the Web page completes filter configuration on the printer 1.

For selecting a filter, the user accesses a Web page for the printer 1 through the client PC 5 and displays a Web page described in FIG. 3. The user determines which filter to use considering a connection interface to the printer 1. As an example, the filter B is used for the logical port A on a network interface.

The user operates selecting the filter B on the logical port A on a Web page in FIG. 3, which is a filter configuration page, and sets up a filter start character string, “START FILTER,” as a start trigger for filter use. Upon completing configuration of such items, the user clicks the “confirm” button on the Web page to finish the filter selection process on the printer 1.

As above described, even when a filter can be configured per interface (or per logical port for networks) on a web page, plural users can use one particular port on a network, and there is a possibility for some users among them not to use any filters. Therefore, it is designed, by configuring “START FILTER” of a filter start character string, to enable the user to determine filter use at a time of print request to the printer 1, similarly to a printer driver. Accordingly, a filter start character string, “START FILTER,” can be configured for each filter installed on the printer 1.

Additionally, the user who does not use a filter can also transmit print document data, regardless of a filter start character string, to the logical port B and D without filter configuration setup.

A preferred embodiment of the present invention can also incorporate a filter end character string, “END FILTER,” as a filter end trigger. It is a filter end character string functioning as a filter terminator to enable the user to end filter function use with his or her arbitrary setup.

The filter end character string can also be configured on a Web page illustrated in FIG. 3. This configuration enables ending filter function in the middle of print document data. Configuring the filter end character string along with the filter start character string allows the user to specify a page or a line in print document data for a filter to function, for example, from the line 10 to the 20 on page 1. Furthermore, by configuring a filter end character string alone, the user can, on a basis of filter processing for all print document data, terminate filter function use halfway through or cancel filter function in the every beginning of the process.

Accordingly, the filter start character string and the filter end character string can be configured for either one to be set up, as well as for both of them unable to be set up.

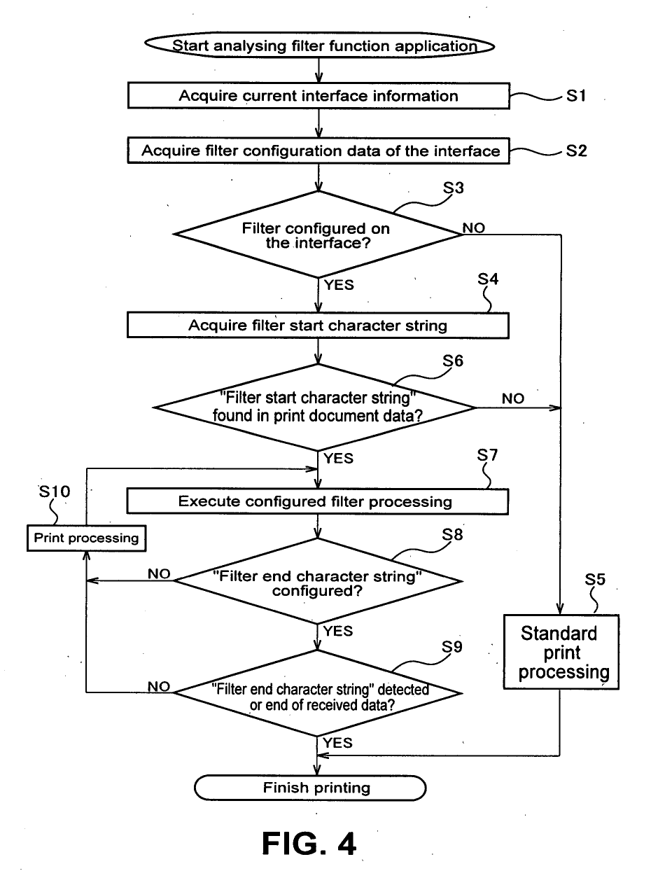

FIG. 4 is a flowchart representing application of filter function.

A process in the flowchart FIG. 4 is executed when print document data is transmitted to the printer 1.

In step S1, a processing for acquiring current interface information is performed. This processing reads a connection interface that the user uses among all other connection interface information of interfaces of the printer 1 connected to the client PC 5. In this step, since the filter B has been selected on the logical port A of a network interface, as aforementioned, the logical port A is read, and the processing proceeds to step S2.

In step S2, a processing for acquiring filter configuration data of the interface is performed. This processing reads, managed by the filter configuration management unit 15, configuration data of a filter on a connection interface the user uses. In this step, data that the filter B has been selected on the logical port A is read, and the processing proceeds to step S3.

In step S3, a processing for determining whether a filter is configured on the interface is performed. This processing proceeds, determined by the filter control unit 19, to step S4 if a filter is configured on the user's interface (YES), and if not (NO), to step S5. In this step, based on the finding that the filter B has been configured on the logical port A, the filter B is read as a filter of use, and the processing proceeds to step S4.

In step S4, a processing for acquiring a filter start character string is performed. In this processing, a filter start character string, “START FILTER,” is searched through print document data at the print document data analysis unit 13. In this step, since the user desires to use a filter, and has written a filter start character string, “START FILTER,” on print document data, acquiring of the “START FILTER” string is performed to proceed to step S6.

In step S5, a “standard print processing” is performed. In this processing, since the user uses an interface without filter configuration, a print document is output from the print output processing unit 7 without filter processing.

In step S6, a processing to determine if there is a filter start character string on print document data is performed. In this processing, a “START FILTER” string acquired from print document data is compared at the print document data analysis unit 13 to “START FILTER” of a filter start character string, having been configured in advance. If identified the same, it is determined that there is a filter start character string (YES) to proceed to step S7, and if determined that a compared object does not exist or two are identified not the same (NO), the processing proceeds to step S5. In this step, a “START FILTER” string is written on print document data, so that the processing proceeds to step S7.

Furthermore, in step S5, due to an execution of “standard print processing,” as aforementioned, a print document is output from the print output processing unit 7 without filter processing.

In step S7, a processing of a configured filter is executed. This processing leads the filter control unit 19 to select and activate the filter B corresponding to the filter implementation unit 17 to proceed to step S8.

In step S8, a processing for determining if a filter start character string is configured is performed. In this processing, it is determined whether a filter end character string is configured. If a filter end character string, “END FILTER,” etc., is configured (YES), the processing proceeds to step S9, and if not (NO), moves to step S10. In this step, since a filter end character string is not configured, it proceeds to step S9.

In step S9, a processing to determine whether a filter end character string has been detected or received data has reached its end is performed. In this processing, when a filter end character string is detected, or received print document data reaches its end (YES), printing finishes. When a filter end character string is not detected, or received print document data has not reached its end (NO), the processing proceeds to step S10.

In step S10, “print processing” is executed, and the processing returns to step S7.

Accordingly, each of such processing enables print output utilizing the filter B in the preferred embodiments of the present invention.

The image forming device of the preferred embodiments of the present invention comprises, on the printer 1 acquiring print document data from the client PC 5 and output a print document, of the filter function unit 11 processing the acquired print document data through a configured filter to enable output of the image. Accordingly, even when a printer driver or utility software is not installed on a data input device, print document data acquired from the client PC 5 can be converted or modified into identifiable data to output an image through the configured filter B on the filter function unit 11. This way, restrictions the user faces in using the printer 1 can be controlled.

The filter function unit 11 comprises the print document data analysis unit 13 to determine to use the filter B, etc. based on a filter start character string that is configured trigger information and a start filter character string of trigger information contained in the foregoing data, and thereby allows the user to select an option of using or not using the filter B, etc., similarly to a printer driver, by configuring a filter start character string and writing a filter start character string on print document data.

Since the trigger information is a filter start character string to signal a start of filter use, the user can easily configure trigger information and write in data.

Since the aforementioned trigger information is a filter start character string to signal a start of filter use and a filter end character string to signal an end of filter use, a start and an end of filter use can be specified and the filter B, etc. can be used for only a part of print document data.

The filter function unit 11 comprises the filter configuration management unit 15 enabling management of the filter A, B, etc. selectively configured on each of multiple types of interfaces connected to the client PC 5; the filter implementation unit 17 implementing multiple types of the filter A, B, etc.; and the filter control unit 19, managed by the filter configuration management unit 15, selectively activating the filter A, B, etc. implemented on the filter implementation unit 17, so that the user can use the filter A, B, etc. in the filter implementation unit 17 based on management of the filter configuration management unit 15. This eliminates inconveniences such as of creating a new filter to improve versatility.

The filter function unit 11 comprises the Web function unit 21 enabling, on a Web page, selection of the filter A and B selectively configured on the logical ports A, B, C, and D of network connections, and thereby allows the user to easily select a filter to use on a Web page.

The filter function unit 11 comprises the Web function unit 21 enabling configuration of the filter on a Web page, so that the user can easily configure a filter on a Web page.

The present document incorporates by reference the contents of Japanese priority document, Japanese Patent Application No. 2005-309121 filed in Japan on Oct. 24, 2005.

Although the invention has been described with respect to a specific embodiment for a complete and clear disclosure, the appended claims are not be thus limited but are to be construed as embodying all modifications and alternative constructions that may occur to one skilled in the art which fairly fall within the basic teaching herein set forth. There are changes that may be made without departing from the spirit and scope of the invention.

Any element in a claim that does not explicitly state “means for” performing a specific function, or “step for” performing a specific function, is not to be interpreted as a “means” or “step” clause as specified in 35 U.S.C. 112, Paragraph 6. In particular, the use of “step(s) of” or “method step(s) of” in the claims herein is not intended to invoke the provisions of 35 U.S.C. 112, Paragraph 6

What is claimed is:

1. An image forming device acquiring data from a data input device to output an image, the image processing device, comprising:
a filter function unit that processes the acquired data through a configured filter to enable output of the image.

2. The image forming device of claim 1, further comprising:
a data analysis unit that determines whether or not to use a filter based on configured trigger information and triggered information included in the aforementioned data, and
the image forming device of claim 1, wherein:
the filter function unit has the data analysis unit.

3. The image forming device of claim 2, wherein
the trigger information is a filter start character string determining a start of filter use.

4. The image forming device of claim 2, wherein
the triggered information is a filter start character string determining a start of filter use and a filter end character string determining an end of filter use.

5. The image forming device of claim 1, further comprising:
a filter configuration management unit that enables management of a filter selectively configured on each of multiple types of interfaces connected to the data input device;
a filter implementation unit implementing multiple types of filters; and
a filter control unit, based on management by the filter configuration management unit, selectively activating a filter in the filter implementation unit, and
the image forming device of claim 1, wherein:
the filter function unit has the filter configuration unit, the filter implementation unit, and the filter control unit.

6. The image forming device of claim 1, further comprising
a Web function unit which, on a Web page, enables configuration of said filter, and the image forming device of claim 1, wherein:
the filter function unit has the Web function unit which, on a Web page, enables configuration of said filter.

7. The image forming device of claim 1, further comprising:
a Web function unit which, on a Web page, enables a selection of a filter selectively configured on each logical port on network interfaces, and
the image forming device of claim 1, wherein:
the filter function unit has the Web function unit which, on a Web page, enables a selection of a filter selectively configured on each logical port on network interfaces.
